(19) United States
(12) Patent Application Publication
(10) Pub. No.: US 2025/0172146 A1
(43) Pub. Date: May 29, 2025

(54) AIR-COOLED COMPRESSOR INSTALLATION WITH INTEGRATED DRYER DEVICE

(71) Applicant: ATLAS COPCO AIRPOWER, NAAMLOZE VENNOOTSCHAP, Wilrijk (BE)

(72) Inventors: Daniel GUARIGLIA, Wilrijk (BE); Tom DE VLOO, Wilrijk (BE)

(21) Appl. No.: 18/843,836

(22) PCT Filed: Mar. 3, 2023
(86) PCT No.: PCT/IB2023/051985

§ 371 Date: Sep. 4, 2024

(30) Foreign Application Priority Data
Mar. 16, 2022 (BE) 2022/5180
Jun. 10, 2022 (BE) 2022/5453
Jun. 14, 2022 (BE) 2022/5471

(51) Int. Cl. F04C 29/00; B01D 53/02; F04C 29/04

(52) U.S. Cl. CPC F04C 29/0092; F04C 29/04; B01D 53/02

(57) ABSTRACT

An air-cooled compressor installation includes a housing in which a motor and compressor element are arranged, and an integrated dryer device with a dryer housing with an internal space and at least one air-cooled heat exchanger. The dryer device is arranged adjacent to the motor. The heat exchanger connects via a first cooling channel to a lateral cooling channel. The space is connected via a transversal cooling channel to an outlet for a first cooling air flow, which transversal cooling channel extends through the lateral cooling channel.

The present invention relates to an air-cooled compressor installation with integrated dryer device.

More specifically, the invention relates to an air-cooled compressor installation provided with a housing comprising at least one air-cooled heat exchanger and which is further provided with an integrated dryer device which is also arranged in said housing.

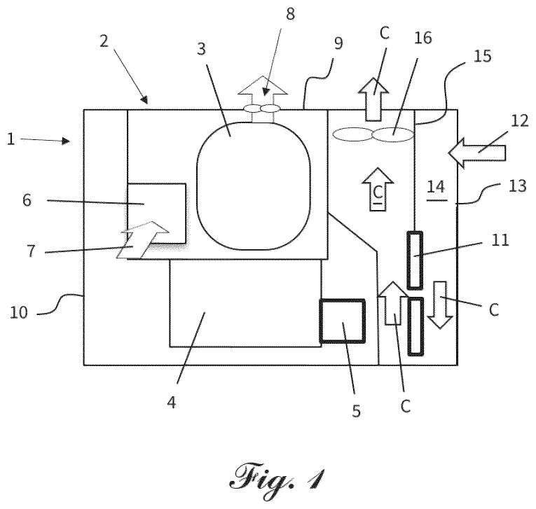

In classic air-cooled compressor installations 1, provided with an integrated dryer, such as shown schematically in FIG. 1, the dryer device 2, which is, for example, configured in the form of a desiccant dryer with a rotatable drum with desiccant material, which drum is arranged in a vessel 3, is placed above the motor 4 which drives the compressor element 5.

As is known, when using such desiccant dryers with a rotatable drum, a warm regeneration gas is passed through the desiccant material in order to regenerate this desiccant material after it has extracted moisture from the compressed gas originating from the compressor element 5.

After passage of the regeneration gas through the regeneration zone in the vessel 3, the regeneration gas is typically cooled in an air-cooled regeneration cooler 6 before being combined with the compressed gas to be dried from the compressor element 5 and passed through the drying zone into the vessel 3. The first cooling air flow 7 used as cooling medium in the regeneration cooler 6 is, in known embodiments of compressor installations 1, discharged by venting into the atmosphere, typically via a discharge 8 in the roof 9 of the housing 10 of the compressor installation 1.

At least part of the heat of compression, generated during the compression of the gas to be compressed in the compressor element 5 of the compressor installation 1, is typically removed through an air-cooled heat exchanger 11, which may be an aftercooler, but in the case of a multi-stage compressor with several compressor elements, can also be an intercooler.

The second cooling air flow 12, which serves as a cooling medium for cooling the compressed gas that is passed through a primary circuit of the heat exchanger 11, is sucked into the known compressor installations 1 through a suction opening, at the top of a side wall 13 of the housing 10 and through an internal cooling channel 14, first downwards along one side of a wall 15 to, and subsequently through, the secondary circuit of said heat exchanger 11 and subsequently, according to the arrows C, along the other side of the wall 15 to a discharge opening in the roof 9 from the housing 10, to be vented into the atmosphere by means of a fan 16.

A disadvantage of the existing compressor installations as shown in FIG. 1 is that the dryer device takes up a relatively large amount of space at a central location within the housing 10, which space cannot be used otherwise, and that also, because of the high positioning of the dryer device 2 above the motor 4, the centre of gravity of the compressor installation 1 is positioned relatively high, making transport of the compressor installation 1 somewhat more challenging for reasons of stability.

The present invention aims at an air-cooled compressor installation with integrated dryer device, which has an alternative configuration whereby a low positioning of the centre of gravity and thus good stability during transport of the compressor installation is obtained. The present invention aims to alternatively or additionally provide space within the housing for the provision of additional components, such as, for example, a sound damper.

To this end, the invention relates to an air-cooled compressor installation with integrated dryer device as claimed in claim 1.

With the aim of better demonstrating the features of the invention, some preferred embodiments of an air-cooled compressor installation according to the invention with an integrated dryer device are described below, by way of example without any limiting character, with reference to the appended drawings, in which:

FIG. 1 schematically represents a classic air-cooled compressor installation with integrated dryer device;

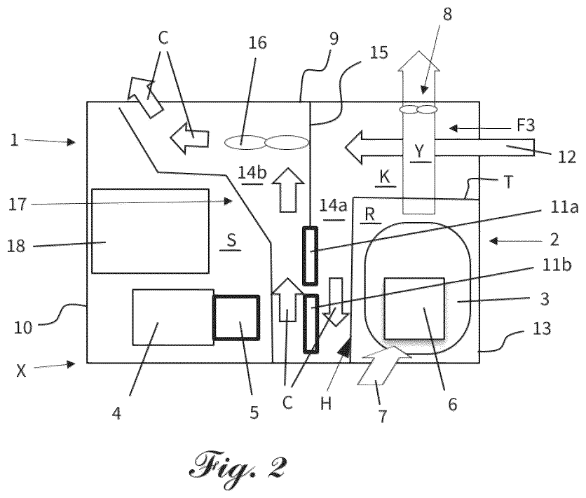

FIG. 2 schematically represents an air-cooled compressor installation according to the invention with integrated dryer device;

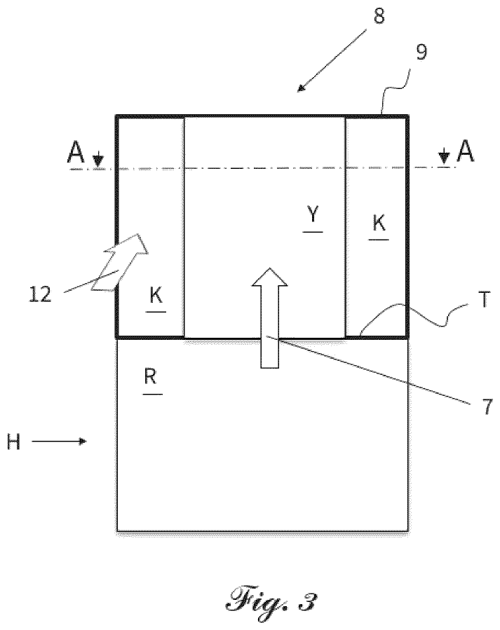

FIG. 3 shows a view according to arrow F3 in FIG. 2 of a part of the compressor installation according to the invention;

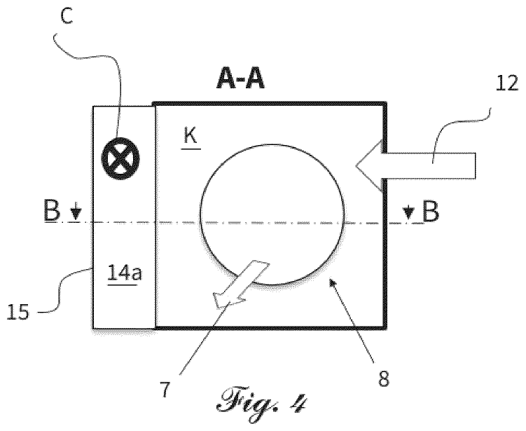

FIG. 4 represents a section according to line A-A in FIG. 3;

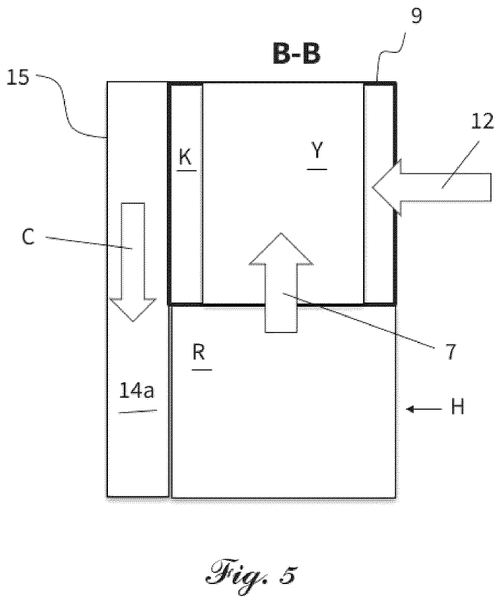

FIG. 5 represents a section according to line B-B in FIG. 4;

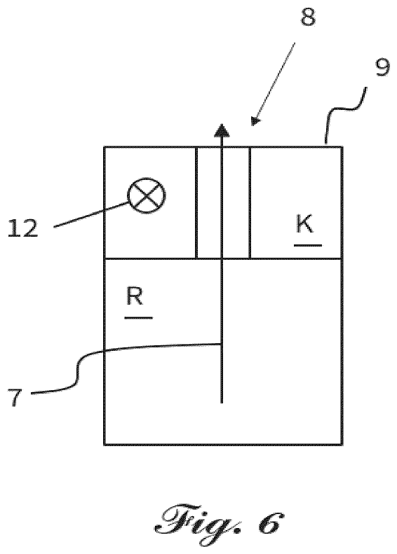

FIGS. 6 to 10 schematically represent a number of alternative embodiments of the part of the compressor installation as shown in FIG. 3.

A classic compressor installation 1 with integrated dryer device 2, as shown in FIG. 1, has already been described in the introduction to this patent specification and will not be repeated here.

A first embodiment of an air-cooled compressor installation 1 according to the invention is shown in FIG. 2. For simplicity, the reference numerals referring to corresponding parts as in FIG. 1 have been reproduced in FIG. 2.

From this FIG. 2, it is immediately clear that there are important similarities vis-à-vis the classic compressor installations, in particular the presence of a housing 10 in which a motor 4, configured to drive one or more compressor elements 5, is provided. Although only one compressor element 5 is schematically shown in the figure, the invention is not limited as such, and the invention is also applicable to multistage compressors comprising more than one compressor element 5, connected in series or parallel.

In the example of FIG. 2, the type of compressor element 5 is an oil-free toothed compressor element, but it should be clear that the invention is not limited to toothed compressor installations, but that it can also be applied with other types of compressors, such as, for example, screw compressors (preferably, but not strictly necessary oil-free), piston compressors, scroll compressors or other types of compressors.

An important difference feature of the compressor installation 1 according to the invention with respect to the classic compressor installations as shown in FIG. 1 consists in that the integrated dryer device 2 is located adjacent to the motor 4 instead of above it. The relevant dryer device 2 comprises a separate dryer housing H which, in this case, connects to the bottom wall X of the housing 10 and which is closed off at the top with a top wall T, all this such that between the top wall T of the dryer housing H and the roof 9 of the housing 10, a first, lateral cooling channel K extends.

According to the invention, the space R, inside the dryer housing H, is connected to a discharge 8 via a second, transversal cooling channel Y.

Within the housing 10, a transversal wall 15 extends from the roof 9, which also comprises at least one, and in this case two, air-cooled heat exchangers 11a and 11b. In this example, the first air-cooled heat exchanger 11a forms an aftercooler for cooling the compressed gas originating from the compressor element 5, while the second air-cooled heat exchanger 11b is configured to cool a cooling liquid guided through the jacket of the compressor element 5 and/or through the casing of the motor 4.

It is clear that the invention is not necessarily limited to such an embodiment of compressor installation 1 with two air-cooled heat exchangers 11a and 11b, but that also only one of such air-cooled heat exchanger 11a can be provided, which is, for example, an aftercooler. Alternatively, of course, more than two air-cooled heat exchangers 11a, 11b can also be provided, for example in the case of a multi-stage compressor installation comprising, for example, two compressor elements 5 connected in series, a first air-cooled heat exchanger 11a can form an intercooler, while a second air-cooled heat exchanger 11b forms an aftercooler and a third air-cooled heat exchanger (not shown in the Figure) is configured to cool a cooling liquid that is used, for example, to cool the jacket of one or more compressor elements 5 and/or the motor 4.

On the other hand, it is also clear that, in the case of two air-cooled heat exchangers 11a and 11b, these can also only consist of an intercooler and an aftercooler and that none of these air-cooled heat exchangers 11a and 11b are configured for cooling a cooling medium that is, for example, passed through a jacket of the compressor element 5 and/or the motor 4.

The aforementioned transversal wall 15 preferably extends to the bottom wall X, such that a first and second cooling channel 14a and 14b respectively are formed on both sides of the wall 15, and that these channels 14a and 14b communicate with each other via a secondary circuit of the one or more heat exchangers 11a and 11.

The first cooling channel 14a communicates upstream via said lateral cooling channel K with a suction opening at the top of the side wall 13 of the housing 10, while the second cooling channel 14b, downstream, communicates with a discharge opening in the roof 9 of the housing 10 through which cooling air by means of a fan 16 can be vented into the atmosphere.

In the example of FIG. 2, the second cooling channel 14b has a downstream increasing flow section over at least part of its length, but this is not a strict requirement according to the invention.

The air-cooled heat exchangers 11a and 11b are incorporated in the wall 15 such that an air flow, flowing through the substantially U-shaped cooling channel 14a-14b, removes heat from the medium, flowing through the primary circuit of these heat exchangers 11a and 11b, in particular compressed gas originating from the compressor element 5 and/or a cooling liquid originating from the compressor element 5 and/or the motor 4.

Another difference of an air-cooled compressor installation 1 according to the invention as shown in FIG. 2 with respect to the classic arrangement as shown in FIG. 1 consists in that in the space S between, on the one hand, a closing wall 17 which keeps the second cooling channel 14b separate from the space inside the housing 10 in which the motor 4 and the compressor element 5 are arranged, and, on the other hand, the wall of the housing 10, a silencer 18 is provided, which is arranged in the flow path of the compression medium, either on the suction side of the compressor element 5, or on the high pressure side thereof. In this case, the relevant silencer 18 is at least partially arranged above the motor 4 and/or above the compressor element 5 and, in this case, between, on the one hand, the motor 4, and, on the other hand, the widening part of the second cooling channel 14b. In the schematic example, the widening of the second cooling channel is such that the silencer 18 extends at least partly between the closing wall 17 and the motor 4.

In this example, the dryer device 2 of the compressor installation according to FIG. 2 is configured in a classical manner in the form of a desiccant dryer with a rotatable drum containing a desiccant material therein such as, for example, silica gel, which drum is arranged in a vessel 3.

The operation of an air-cooled compressor installation 1 according to the invention with integrated dryer device 2 is very simple and as follows.

A gas to be compressed, e.g. air, is sucked in by the compressor element 5, driven by the motor 4, and is then split into a first regeneration gas flow which is directed to the regeneration zone in the vessel 3, and a second compressed gas flow, which is first passed through the primary circuit of an aftercooler 11a, and is subsequently directed, via a condensate separator, not shown in the figures, to the drying zone in the vessel 3 where the desiccant material in the drying drum will adsorb moisture from the compressed gas.

The regeneration gas flow leaving the regeneration zone is cooled in the air-cooled regeneration condenser 6 and is subsequently, after removal of condensate by means of a condensate separator, not shown in the figure, combined with the compressed gas to be dried originating from the aftercooler 11a, to pass through the drying zone.

The first cooling air flow 7, which is used for cooling the regeneration gas flow in the regeneration cooler 6, is discharged from the space R via the second, transversal cooling channel Y to the discharge 8 and thus vented into the atmosphere. In the example shown, to this end, a fan is provided in the flow path of the cooling air for cooling the regeneration cooler 6, specifically in the second, transversal cooling channel Y.

Via the suction opening at the top of the side wall 13 of the housing 10, a second cooling air flow 12 is sucked in and flows through the first lateral cooling channel K that extends between the roof 9 of the housing 10 and the top wall T of the dryer housing H, along the outer wall of the the second transversal cooling channel Y extending through the first lateral cooling channel K.

Subsequently, the first cooling air flow 12 is deflected downwards into the first cooling channel 14a, through the secondary circuit of the first and second air-cooled heat exchangers 11a and 11b, where this air flow functions as a cooling medium and thus removes heat, on the one hand, from the compressed gas passing through the primary circuit of the first air-cooled heat exchanger 11a, and, on the other hand, from the cooling liquid originating from the jacket of the motor 4 and/or the compressor element 5, which is passed through the primary circuit of the second air-cooled heat exchanger 11b.

Subsequently, the second cooling air flow 12 continues to flow in the flow direction indicated by the arrows C, upwards, under the impulse of the fan 16, to finally be discharged via the discharge opening in the roof 9.

Due to the fact that the integrated dryer device 2 is located adjacent to the motor 4 in the housing 10 instead of above the motor 4, the centre of gravity of the air-cooled compressor installation 1 according to the invention is lower than in conventional air-cooled compressor installations, while space is also available for additional components, such as the silencer 18.

It is by no means evident that in the air-cooled compressor installation 1 according to the invention, the first and second cooling channel 14a and 14b extend between the space S, in which the motor 4 and the compressor element 5 are located, and the space R, in which the vessel 3 and the regeneration cooler 6 are located, as this has substantial implications for the different cooling air flows 7 and 12 within the housing 10. However, the alternative embodiments according to the invention offer an elegant solution by providing a first lateral cooling channel K and a second transversal cooling channel Y which, despite the fact that they intersect each other in the space above the dryer housing H, have substantially no adverse effect on the cooling efficiency of the relevant cooling air flows 7 and 12, while beneficial effects can still be obtained, such as increased stability during transport of the compressor installation 1 and extra space for additional components such as the silencer 18.

FIGS. 3 to 5 schematically show on a larger scale a few details of a first embodiment of an air-cooled compressor installation 1 according to the invention with integrated dryer device 2. FIG. 3 clearly shows the trajectory of the first cooling air flow 7 which is fed upwards from the space R in the dryer housing H via the second transversal cooling channel Y to the discharge 8.

The first lateral cooling channel K extends substantially in a direction that is perpendicular or substantially perpendicular to the main direction of the second transversal cooling channel Y, such that the second cooling air flow 12 flows on both sides around the outer wall of the second transversal cooling channel Y. Preferably, but not strictly necessary, the second transversal cooling channel Y extends substantially centrally through the first lateral cooling channel K, such that the space for throughflow with the second cooling air flow 12 on both side of the second transversal cooling channel Y has the same size, or substantially the same size.

As shown in FIG. 4, the transversal section of the second transversal cooling channel Y has an elliptical shape, and even more preferably a circular shape. It has been found that such a configuration has little or no negative impact on the cooling efficiency of the second cooling air flow 12 since turbulences remain limited.

The second cooling air flow 12 subsequently deflects downward against the transversal wall 15 which, together with a side wall of the dryer housing H and two side walls of the housing 10, defines the first cooling channel 14a. This is shown in FIG. 5.

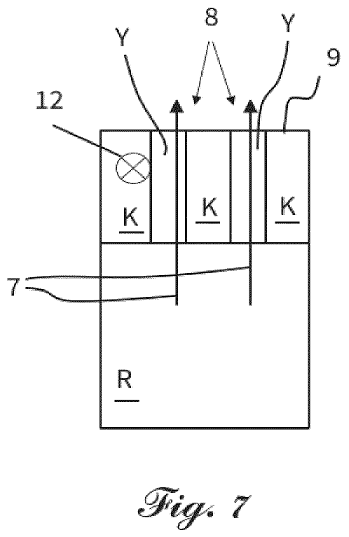

In FIG. 6, the view of FIG. 3 is resumed as reference for comparison of the alternative embodiments shown in FIGS. 7 to 10.

As shown in FIG. 7, according to the invention, more than one transversal cooling channel Y can be provided which directs cooling air from the space H in the dryer housing H to the discharge 8. The transversal cooling channels Y are preferably placed at such a distance from each other that they minimally disturb the second cooling air flow 12. Preferably, but not necessarily, the walls of the various transversal cooling channels Y all have an elliptical or circular cross-section.

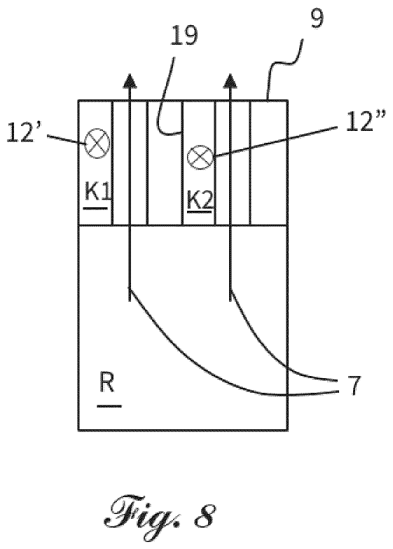

FIG. 8 shows yet another embodiment, in which, in this case, two parallel or substantially parallel lateral cooling channels K1 and K2, respectively, extend adjacent to each other and are separated from each other by means of a partition wall 19.

Through each of these lateral cooling channels K1 and K2, in this example, a respective transversal cooling channel Y extends from the space R in the dryer housing H.

In such an embodiment, at least the first cooling channel 14a can also be split into two parallel channels, respectively a first partial channel along which a first portion of cooling air 12′ is directed to a first air-cooled heat exchanger 11a, and a second partial channel along which a second portion of cooling air 12′ is directed to a second air-cooled heat exchanger 11b.

Depending on the required cooling flow for the respective air-cooled heat exchangers 11a and 11b, the dimensions of the lateral cooling channels K1 and K2 can be adjusted as desired.

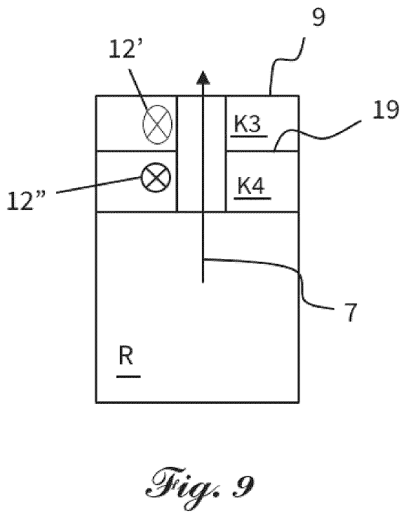

FIG. 9 also shows an embodiment provided with two parallel lateral cooling channels K3 and K4, but in this case, these lateral cooling channels K3 and K4 extend one above the other. Also in this case, the respective lateral cooling channels K3 and K4 are separated from each other by means of a partition wall 19, which, in this example, but not necessarily, is substantially parallel to the top wall T of the dryer housing H.

Again, in such an arrangement, at least a portion of the first cooling channel 14a may be split—essentially in line with the splitting of the lateral cooling channel K, such that a first portion of cooling air 12′ flowing through a first lateral cooling channel K3 is directed to a first air-cooled heat exchanger 11a, while a second portion of cooling air 12″ flowing through a second lateral cooling channel K4 is directed to a second air-cooled heat exchanger 11b.

In this example, only one transversal cooling channel Y extends through the respective lateral cooling channels K3 and K4, but it should be clear that more than one transversal cooling channel Y can also be provided in this embodiment, for example as in the example of FIG. 7.

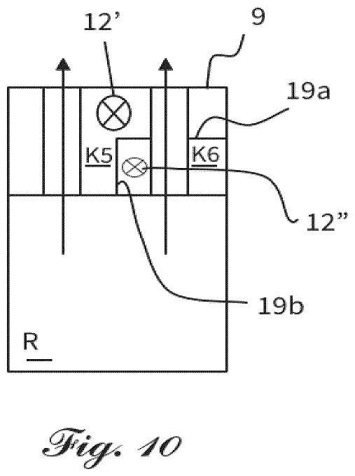

Finally, FIG. 10 shows yet another embodiment, in which again more than one lateral cooling channel is provided, but in which the first lateral cooling channel K5 extends at least partly around the second lateral cooling channel K6 in longitudinal direction. To this end, the respective lateral cooling channels K5 and K6 are separated from each other by two or more partition walls 19a and 19b. It will be clear that also in this embodiment, the dimensions of the respective lateral cooling channels K5 and K6 can be adjusted to the required cooling capacity for the respective air-cooled heat exchangers 11a and 11b.

In this example, the area of the cross section of the first lateral cooling channel K5 is, for example, significantly larger than the area of the cross section of the second lateral cooling channel K6.

Although in each of the embodiments shown, a maximum of two lateral cooling channels are shown, it is not excluded according to the invention that more than two lateral cooling channels are provided, which may or may not be communicating with a separate cooling channel 14 and thus supply cooling air to different air-cooled heat exchangers. After all, as mentioned earlier, the number of air-cooled heat exchangers 11 should not be limited to one or two, but three or more air-cooled heat exchangers can also be provided in the air-cooled compressor installation 1 according to the invention.

Although in the described examples the dryer device 2 is formed by a desiccant dryer, the invention is not necessarily limited as such, since the dryer device 2 can also comprise another type of dryer, such as a cooling dryer containing an air-cooled condenser. In such case, no portion of the hot compressed gas needs to be branched off for regeneration of desiccant material, but the entire flow of compressed gas originating from the compressor element 5 is still cooled in an air-cooled aftercooler and is subsequently directed to the secondary circuit of a heat exchanger, the primary circuit of which forms the evaporator of a cooling circuit, in order to cool the compressed gas to a temperature below its dew point in order to be able to separate condensate from the compressed gas.

In that case, the air-cooled heat exchangers 11a and 11b can therefore still consist of an aftercooler and optionally an intercooler, and in that case, a first cooling airflow 7 must still be provided in the dryer housing H for cooling a condenser that is part of said cooling circuit of the cooling dryer.

The present invention is by no means limited to the embodiments described as an example and shown in the figures, but an air-cooled compressor installation according to the invention with an integrated dryer device can be realized in all kinds of shapes and dimensions without departing from the scope of the invention as defined in the accompanying conclusions.

1.-19. (canceled)

20. An air-cooled compressor installation provided with a housing in which a compressor element, driven by a motor is arranged, and in which also:
an integrated dryer device with a dryer housing is provided with an internal space;
at least one air-cooled heat exchanger is provided,
wherein said dryer device is arranged adjacent to said motor; in that said air-cooled heat exchanger has a secondary circuit which connects via a first cooling channel to a lateral cooling channel; and in that said space is connected via a transversal cooling channel to an out-let for a first cooling air flow, which transversal cooling channel extends through the lateral cooling channel.

21. The air-cooled compressor installation according to claim 20, wherein said dryer device comprises a desiccant dryer with a regeneration cooler which is configured such that the first cooling air flow forms the cooling medium for regeneration gas that is passed through the regeneration cooler.

22. The air-cooled compressor installation according to claim 20, wherein the transversal section of said transversal cooling channel has an elliptical or round shape.

23. The air-cooled compressor installation according to claim 20, wherein the transversal cooling channel extends substantially centrally through the lateral cooling channel, such that the space for the throughflow of the second cooling air flow on both sides of the transversal cooling channel has the same size or substantially the same size.

24. The air-cooled compressor installation according to claim 20, wherein it is a multi-stage compressor installation comprising at least two compressor elements and that it further comprises two air-cooled heat exchangers, in particular a first air-cooled heat exchanger forming an intercooler and a second air-cooled heat exchanger forming an aftercooler, and that the respective secondary circuits of these heat exchangers form a connection between said first cooling channel and a second cooling channel, which first and second cooling channel extend on both sides of a transversal wall arranged in the housing.

25. The air-cooled compressor installation according to claim 20, wherein said first cooling channel extends perpendicular or substantially perpendicular to the lateral cooling channel.

26. The air-cooled compressor installation according to claim 20, wherein said lateral cooling channel extends at least partly between, on the one hand, an upper wall of the dryer housing, and, on the other hand, the roof of the housing.

27. The air-cooled compressor installation according to claim 20, wherein the internal space is connected via a plurality of transversal channels to a discharge in the roof of the housing and in that each of said transversal channels extends through said lateral channel.

28. The air-cooled compressor installation according to claim 20, wherein two or more parallel or substantially parallel lateral cooling channels are provided that are separated from each other by means of a partition wall.

29. The air-cooled compressor installation according to claim 28, wherein said lateral cooling channels extend adjacent to each other.

30. The air-cooled compressor installation according to claim 28, wherein said lateral cooling channels extend one above the other.

31. The air-cooled compressor installation according to claim 28, wherein one of said lateral cooling channels extends at least partly around another lateral cooling channel.

32. The air-cooled dryer installation according to claim 28, wherein a first lateral cooling channel is in communication with a first partial channel of the first cooling channel, while a second lateral cooling channel is in communication with a second partial channel of the first cooling channel.

33. The air-cooled dryer installation according to claim 32, wherein said first partial channel is connected to a first air-cooled heat exchanger, while a second partial channel is connected to a second air-cooled heat exchanger.

34. The air-cooled dryer installation according to claim 20, wherein said air-cooled heat exchanger is configured to cool a cooling medium originating from a cooling jacket of said compressor element and/or of said motor.

35. The air-cooled dryer installation according to claim 24, wherein in a space between, on the one hand, a closing wall that keeps the second cooling channel separate from the space inside the housing in which the motor and the compressor element are arranged, and on the other hand, the wall of the housing, a silencer is provided which is arranged in the flow path of the compression medium.

36. The air-cooled dryer installation according to claim 20, wherein said compressor element concerns an oil-free toothed com-pressor element.

37. The air-cooled dryer installation according to claim 24, wherein said second cooling channel has a downstream increasing flow section over at least part of its length.

38. The air-cooled dryer installation according to claim 20, wherein said dryer device comprises a cooling dryer with a cooling circuit with an air-cooled condenser, configured to be cooled by means of the first cooling air flow.
